(19) United States
(12) Patent Application Publication
(10) Pub. No.: US 2007/0168495 A1
(43) Pub. Date: Jul. 19, 2007

(54) Systems and methods for network data storage

(76) Inventors: Richard S. Rothstein, McLean, VA (US); Winder Keating, Annapolis, MD (US)

Correspondence Address: PILLSBURY WINTHROP SHAW PITTMAN, LLP, P.O. BOX 10500, MCLEAN, VA, 22102, US

(21) Appl. No.: 11/328,089

(22) Filed: Jan. 10, 2006

Related U.S. Application Data
(60) Provisional application No. 60/642,509, filed on Jan. 11, 2005.

(51) Int. Cl. G06F 15/173

(52) U.S. Cl. 709/224

(57) ABSTRACT

A data storage system that is based on a unique configuration of hardware and collection of open source software. In a preferred networked implementation, the system includes a plurality of data storage servers arranged in a cluster and each being accessible via a network switch to an external network. Each data storage server includes a communications bus, disk drives, network adaptor, and control software. The control software consists essentially of only open source software, including the EXT3 node file system, GNU Privacy Guard (GPG) security, domain name system (DNS) IP addressing, an enterprise volume management system (EVMS), heartbeat monitoring, NFS and CIFS network protocols, data replication block device (DRBD) data mirroring, a distributed lock manager (DLM), a general file system (GFS) and Andrew file system (AFS), AND open single system image (SSI) software.

This application claims the benefit of U.S. Provisional Application No. 60/642,509, filed Jan. 11, 2005, which is incorporated herein by reference.

### BACKGROUND

1. Field of the Invention

The present invention is related to data storage. More particularly, the present invention is related to a storage system and methodology based predominantly on commodity hardware and a unique combination and configuration of Open Source software, protocols and approaches to information technology management.

2. Background

The volume of data that must be stored by business and government is growing 40% to 60% per year. One major factor driving this growth is the “digitalization” of business and government. On-line business and government, real-time business and government, replacement of paper with digital media, software applications such as Enterprise Resource Planning (ERP) and Customer Relationship Management (CRM), the increasing use of digital communications such as email and instant messaging, new technology such as Radio Frequency Identification (RFID), and the increasing amount of digital “content” all produce larger and larger amounts of data which must be stored in order to be useful.

As just one example, it is estimated that the implementation of RFID technology by WalMart will generate approximately seven Terabytes of data per day, all of which must be stored. In addition, regulations such as Sarbanes-Oxley, Check 21 (which addresses digitization of paper checks), and the Health Insurance Portability and Accountability Act place legal requirements on business to preserve data.

The magnitude of this phenomenon has been addressed by numerous sources including Sun Microsystems: “. . . the amount of data in an average enterprise will triple in the next two to three years”; International Data Corporation (IDC): “Enterprise storage needs are doubling every twelve to eighteen months”, and Business Week (Oct. 19, 2004) “data is growing 40 to 60% annually in large organizations.”

In addition to just keeping up with demand, organizations face other storage challenges. With the move to on-line, real-time business and government, critical data must be protected from loss or inaccessibility due to software or hardware failure. Today, many storage products do not provide complete failure protection and expose users to the risk of data loss or unavailability. For example, many storage solutions on the market today offer protection against some failure modes, such as processor failure, but not against others, such as disk drive failure. Many organizations are exposed to the risk of data loss or data unavailability due to component failure in their data storage system.

Organizations must be able to recover from a disaster impacting a primary data center—fire, flood, tornado, terrorist attack, plane crash, or being shut down because a mysterious white powder is discovered. The obvious answer is to continuously copy key data to a secure, remote location. Today, however, this is difficult and expensive. Remote copies, if they are made at all, are seldom complete and up-to-date thus exposing organizations to the consequences of lost or unavailable data. The Sep. 11, 2001 terrorist attack, the recent North East blackout, and a series of tornadoes and hurricanes have driven home the necessity of having backup copies of critical data available in the event of a disaster.

Between 24/7 operation and the inevitable problems that crop up during overnight processing, the “backup window” is often insufficient to make backup copies of critical data. When the inevitable situation arises where backup copies are needed, they are often not available or can only be created through major effort and expense.

Events such as companies losing backup tapes containing personal data for thousands of individuals and hackers stealing sensitive financial data illustrate the importance of security when storing sensitive data.

The proliferation of storage technologies, vendors, and products in recent years has created complexity. Many organizations have expensive and inefficient storage “islands”—multiple, incompatible storage systems from multiple vendors.

Finally, storage represents a major cost for most organizations. IBM estimates that data storage will account for 22% of IT budgets by 2007. The ability to give organizations more for their storage dollar represents a major opportunity to free resources for other uses.

The data storage market is divided into two major segments: Direct Attached Storage (DAS) and Network Storage. As the name implies, DAS consists of disks connected directly to a server. DAS may be supplied by the server manufacturer or by a third party. DAS is only directly accessible by the server to which it is attached. That makes DAS difficult to share among applications or other servers. In addition, each server's storage must be managed individually. This leads to inefficiencies.

The alternative to DAS is Network Storage, i.e., disks that are attached to a network rather than a specific server and can then be accessed and shared by other devices and applications on that network. Network storage can be managed as a single pool serving any number of servers. The flexibility and efficiency of network storage have made it appealing to IT organizations of all sizes. In 2003 (according to IDC) network storage first accounted for more than 50% of all disk sales for the first time and the network storage's proportion has been growing ever since.

Network Storage is divided into two segments: Storage Area Networks and Network Attached Storage.

Storage Area Networks (SANs) address the needs of large organizations' high volume, mission critical applications. SANs typically use Fibre Channel communications networks that are high speed (2 Gigabits/sec.) but difficult and expensive to install and operate. Because of the ten kilometer distance limitation inherent in Fibre Channel, SANs have mainly been installed in data centers. A key technical distinction of SANs has been that they support block level data storage, which is compatible with many business applications. SANs that use Internet Protocol (IP) networks rather than Fibre Channel networks are now emerging as an alternative to Fibre Channel SAN's. These systems typically use the Internet Small Computer System Interface (iSCSI) communications protocol.

Network Attached Storage (NAS) evolved from the low end. Think of NAS as a new name for a file server. NAS devices typically use IP as their network protocol, so they are compatible with existing infrastructure and simple to manage. They are inexpensive and typically provide a lower level of performance (bandwidth and Input/Output rates) and scalability than Fibre Channel SANs. Unlike SANs, which act as block level storage devices, NAS systems act as file level storage devices. While SANs have mainly been the tool for large enterprise data centers, NAS has been a tool for departments and small/medium sized organizations. Many organizations now have a large number of NAS systems installed. Consolidating multiple NAS installations into a single system reduces the complexity of an organization's information technology infrastructure, reduces administrative workload, and improves service levels.

There are many organizations that rely on what the storage industry classifies as “enterprise class” storage systems. These organizations:
have large amounts of data (multiple to hundreds of Terabytes or more),
have a high volume of activity against that data, and
depend on secure, reliable, “always-on” access to that data.

Low cost NAS and SAN storage systems do not deliver the throughput, scalability, reliability, or business continuity these organizations need for their high volume, mission critical applications. Up to now, the only data storage systems that met the needs of these organizations have been based on expensive, custom-developed technology. For example, many storage systems on the market today rely on custom operating systems optimized to run storage systems. Other approaches used for storage systems include custom-developed, special-purpose hardware and special-purpose network protocols. Historically, that was the only way to achieve high levels of throughput, reliability, and business continuity.

The leading suppliers of enterprise-class network storage systems today include EMC, HP, IBM, SUN, Hitachi, and Network Appliance. All of the enterprise-class network data systems available today are built using custom-developed software. Most also rely on custom-developed hardware.

In view of the foregoing, there is a continuing need to provide more efficient, yet less expensive data storage systems.

### SUMMARY OF THE INVENTION

The present invention addresses this need by capitalizing on two technology trends in order to develop a new approach for network data storage: the maturing of the open source software movement and the emergence of a new generation of off-the-shelf hardware.

Open source software is developed and supported by collaborative communities of developers freely sharing source code and is available for use without license fees. The open source movement matured during the 1990's to the point where a 2004 survey found 1.1 million developers in North America alone participating in open source development. Recent studies have shown that open source software offers advantages over proprietary software including fewer defects; faster fixes when a defect is detected; fewer security vulnerabilities; richer, faster innovation; and lower costs. There are thousands of open source software components including databases, application servers, file systems, encryption, etc.

At the same time that open source software has become available, Moore's law has continued and commodity hardware components have continued to increase in power and come down in cost. Low cost, off-the-shelf components such as 64 bit processors, Peripheral Component Interconnect (PCI) busses, and Gigabit Ethernet network devices can now more easily provide the hardware capabilities needed for enterprise class data storage.

The present invention provides reliable and secure storage for large volumes of data; maximizing the use of low cost, off-the-shelf technology. The approach uses off-the-shelf, commodity hardware components such as disk drives, general-purpose microprocessors, and network interface cards along with an assembled set of open source software components that substitute for the custom-developed software used in prior art data storage systems. The design objective was to develop a system with the following capabilities:
Scalability—can be expanded to 8 Petabytes of capacity (8 Petabytes is the limit of 64 bit addressing).
Availability—provide protection against data loss or unavailability from virtually any failure mode—processor, software, disk, etc.—and provide totally transparent failover in the event of any failure.
Business Continuity—provide continuous, remote replication of all data to protect against data loss in the event of an incident impacting a primary processing facility.
Performance—provide high rates of data access and maintain performance as capacity is added.
Backup—make full backup copies of any amount of data in one hour with no interruption of primary processing.
Flexibility—provide the capability to swap components, meet specific application requirements, e.g., video streaming, customer requirements, e.g., very high transactions rates, or connectivity requirements, e.g., Fibre Channel.
Simplicity—provide a common architecture for different types of storage (Storage Area Network, IBM Mainframe, Network Attached Storage) plus “virtualization” that allows all storage resources to be managed as a single pool.
Security—provide the capability to encrypt and control access to sensitive data to reduce the risk of unauthorized access or tampering.

The details for accomplishing these objectives as well as others will be better appreciated upon a reading of the following detailed description in conjunction with the associated drawings, in which:

### BRIEF DESCRIPTION OF THE DRAWINGS

FIG. 1 shows a data storage server or node in accordance with embodiments of the present invention.

FIG. 2 depicts a data storage server's connectivity in a networked environment.

FIG. 3 illustrates how several data storage servers can be combined in parallel as nodes in a cluster in accordance with embodiments of the present invention.

FIG. 4 illustrates a more detailed view of the architecture of data storage server in accordance with embodiments of the present invention.

FIG. 5 shows a hardware/software architecture of the data storage server in accordance with the present invention.

FIG. 6 shows a cluster of multiple data storage servers seen as a single file and system in accordance with the present invention.

FIG. 7 shows a single file and system view for multiple clusters of storage servers in accordance with the present invention.

FIGS. 8 and 9 illustrate continuously replicating data from primary storage to mirror storage in accordance with the present invention.

FIG. 10 illustrates an embodiment comprising primary, mirror and backup storage in accordance with the present invention.

FIG. 11 depicts copying from mirror to backup storage servers in parallel in accordance with the present invention.

FIG. 12 depicts copying from mirror to backup clusters in parallel in accordance with the present invention.

FIG. 13 shows storing large files for delivery at high speed without interruption in accordance with the present invention.

FIG. 14 shows delivering a file to a single user and FIG. 15 shows delivering a file to multiple users in accordance with the present invention.

FIG. 16 shows the use of loopback file mechanisms in accordance with the present invention.

### DETAILED DESCRIPTION

The present invention comprises a network data storage system that uses a combination of open source software components for software functionality. Notably, these software components were developed for other purposes, and not for use in a network data storage system. In other words, the embodiments of the present invention employ specific combinations of open source software components that together perform the functions of a network data storage system, but were never intended to be employed in such a manner.

The network data storage system in accordance with embodiments of the present invention comprises a common hardware/software platform that supports both block level data storage (i.e., Storage Area Network or SAN) and file level data storage (i.e., Network Attached Storage or NAS). The platform provides high performance, high availability, continuous local and remote data replication, and local and remote transparent failover.

A wide range of connectivity options is available including: Gigabit and 10 Gigabit Ethernet, Fibre Channel (FC), iSCSI, and IBM mainframe. The architecture scales to 8 Petabytes while maintaining a single file system view. Full backup copies of any volume of data can be completed in one hour or less, without impacting ongoing production processing activities. The platform is preferably fully compatible with storage management tools provided by most storage vendors and third parties as well as open source management tools.

The system may be configured to provide solutions for a variety of common data storage requirements including:
Network Attached Storage (NAS) consolidation—replacing multiple NAS implementations with a single, centrally managed NAS system,
Storage Area Network (SAN) consolidation—eliminating multiple SAN implementations by installing a single, centrally managed IP and/or Fibre Channel SAN infrastructure,
Digital media storage—providing the specialized capabilities (e.g., high bandwidth) needed to deliver high performance video, image, and other digital media storage and retrieval,
IBM mainframe storage, and
Enterprise storage—combining block mode (SAN) and file mode (NAS) data storage in a single infrastructure with a common management framework.

The data storage system in accordance with the present invention, preferably uses general-purpose server technology as a basis for data storage, specifically the AMD Opteron® 64 bit Central Processing Unit (CPU), which uses dual core technology to provide higher processing throughput than other microprocessors, and the 64 bit version of the Linux operating system. General-purpose server technology, the present inventors have found, when configured appropriately, has advanced to where it holds the clear advantage over proprietary technology in price/performance for a data storage system. General-purpose server technology configured appropriately provides additional advantages in standardization and continued advances fueled by the large R&D investment driven by the $50B server market.

In addition to the Linux operating system, a combination of additional open source software components provides the software functions needed by a network data storage system such as file and volume management, connectivity, mirroring, failover, and security. Open source software components used in embodiments of the present invention include Linux 2.6, the Extended Volume Management System (EVMS), the Global File System (GFS), the Andrew File System (AFS), GNU Privacy Guard (GPG), and others. This specific combination of open source components and a small amount of application-specific software results in advanced storage capabilities including a global file system that provides a single file system view for up to 8 Petabytes of data, high availability, business continuity, virtualization and management of physical storage resources, and embedded data security.

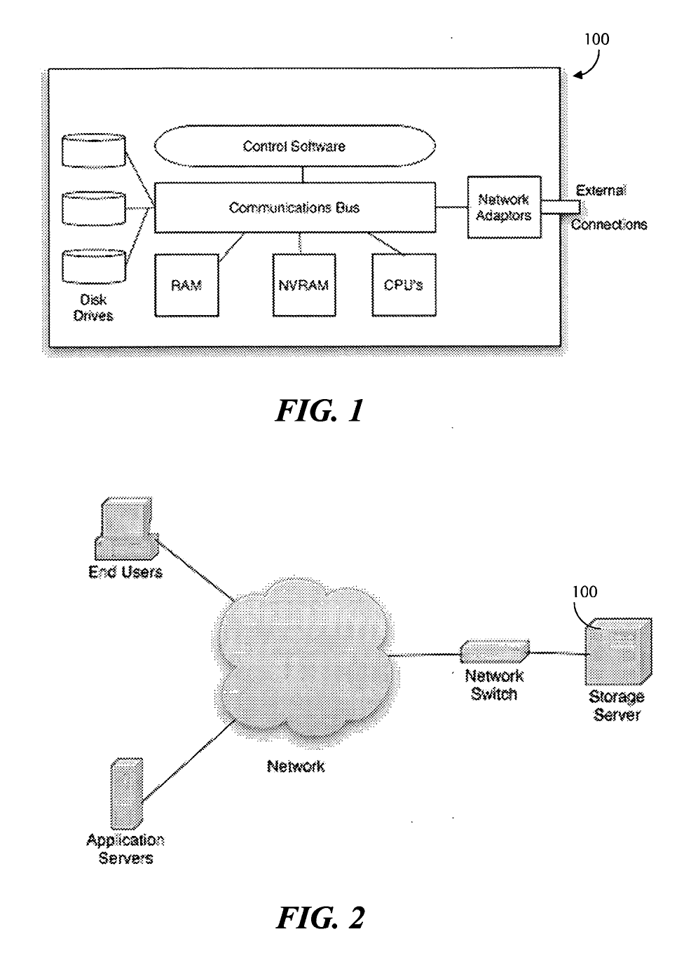

The foundation of the network data storage system in accordance with the present invention is the data storage server or node 100 shown in FIG. 1.

This device is a complete data storage server providing one Terabyte or more of storage capacity. Each storage server preferably houses disk drives, Central Processing Units (CPU's), Random Access Memory (RAM), and battery-backed non-volatile RAM (NVRAM). Internal communications is provided by Peripheral Component Interconnect (PCI) busses. External network connectivity is provided by Ethernet Network Adaptors, Fibre Channel Host Adaptors, or a combination of Ethernet and Fibre Channel adaptors. Software comprises the storage system-unique configuration of open source software components running on Linux. Each data storage server may be housed in a rack mountable chassis.

As shown in FIG. 2, a data storage server (or node) 100 can be accesses by end users or other servers via a communications network.

The network may be an Internet Protocol (IP), Fibre Channel, or Internet Small Computer System Interface (iSCSI) network or IBM mainframe technology: Enterprise Systems Connection (ESCON) or Fiber Connectivity (FICON).

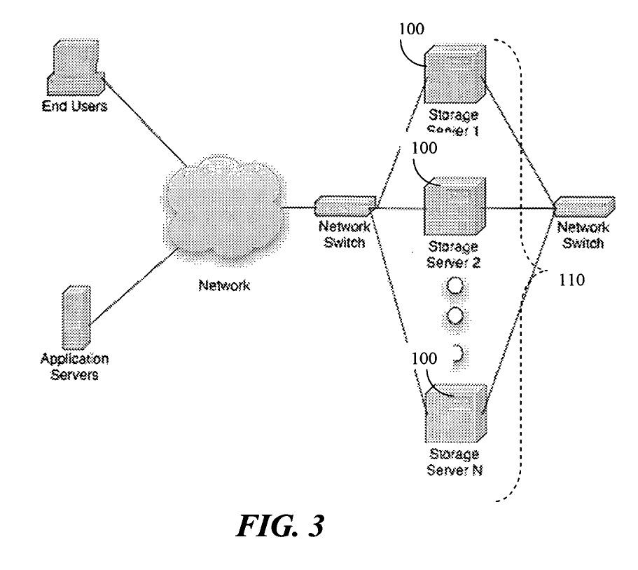

As shown in FIG. 3, data storage servers 100 can be combined in parallel as nodes in a cluster 110 to provide additional storage for up to 8 Petabytes of data.

Since each node 100 is a self-contained storage server with its own processor, RAM for data caching, disks, and network connections, this cluster architecture eliminates bottlenecks and ensures that performance remains constant as capacity is added. The cluster approach enables a number of advanced storage capabilities including making backup copies of significant amount of data in as little as an hour, simple capacity expansion by adding nodes, maintaining performance levels as capacity is added, and locating storage locally and/or remotely as needed.

Through the capabilities of the software, a single file system view is maintained for a single cluster or multiple clusters. All data is seen as a single directory. In addition, the software provides a single system view. All the servers in one cluster or multiple clusters appear to users as a single device.

In accordance with a preferred implementation, the data storage system uses an open architecture. Use of proprietary hardware or software is preferably avoided, and the platform is standards-based. For example, all communications use standard protocols such as TCP/IP and iSCSI rather than the proprietary protocols used in some data storage systems. The operating system is a standard version of Linux. Hardware is preferably based on standard, off-the-shelf components.

FIG. 4 illustrates a more detailed view of the architecture of data storage server in accordance with embodiments of the present invention. This architecture is preferably implemented using commercially available, off-the-shelf components. Details will vary based on the requirements (file sizes, workload, connectivity, etc.) and the hardware available in the market (motherboards, disk drives, network adaptors, etc.).

Commercially available motherboards are used to integrate the hardware components. The motherboard contains slots for the CPU's, memory, etc. as well as associated components such as power supplies and connectors.

CPU's are the AMD Opteron®. The base configuration is two dual-core CPU's per server. As needed, additional CPU's can be used for a single storage server.

The HYPERLINK bus, provided by the AMD Opteron, and the Opteron chip set for inter-CPU communications and to connect the CPU's to the other hardware components.

Other hardware components are connected to the motherboard and are integrated using Peripheral Component Interconnect (PCI) slots on the motherboard. The current commercially available motherboards provide PCI-X and Express Mode PCI.

Random Access Memory (RAM) chips are connected using PCI slots.

Battery-backed Non-Volatile RAM (NV-RAM) is mounted on a card which is connected using a PCI slot.

Network Interface Cards (NICs) may be Gigabit Ethernet, ten Gigabit Ethernet, iSCSI, or Fibre Channel. They are connected using PCI slots.

Disk Drives may be Serial Advanced Technology Attachment (SATA) or Small Computer System Interface (SCSI) drives. Disk drives are controlled by SATA or SCSI disk controllers. Controllers are connected using PCI slots.

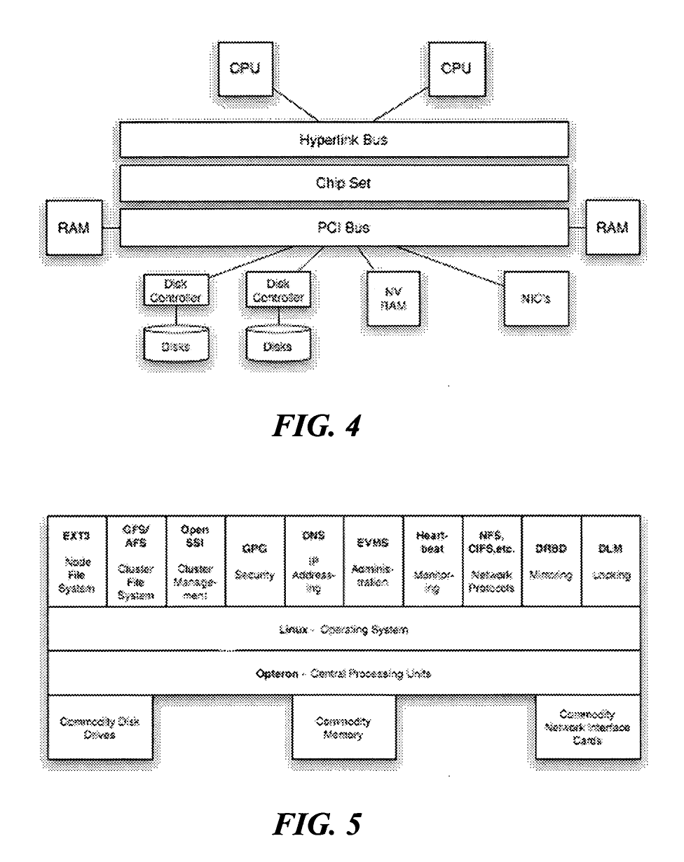

FIG. 5 shows a preferred hardware/software architecture for data storage server 100. Data storage functionality is provided by a suite of open source software components controlled by the Linux operating system. In one implementation (and, of course, others are possible), all the software running on a storage server 100 uses AMD Opteron® microprocessors which are used because their dual core technology provides additional processing throughput. Data is stored on off-the shelf Serial Advanced Technology Attachment (SATA) or Small Computer System Interface (SCSI) disk drives. Off-the-shelf Random Access Memory (RAM) is used for data caching and other functions. Connectivity is provided by off-the-shelf network adaptors.

The open source software components that may be combined to provide the software functionality needed for data storage comprise:

64 bit Linux—Operating system; controls all other software running on the server.

The large address space (64bit) meets memory and file size needs.

EXT3—Server file system; manages all local data on a single server (node) and logs all file activity.

General File System (GFS) and the Andrew File System (AFS)—Cluster file system; GFS provides a single-file-system client view for multiple independently administered servers in a cluster. AFS provides a single provides a single file system view for multiple, and optionally geographically dispersed, clusters. Both provide the capability to stripe data across multiple storage servers 100 and distribute metadata.

Open Single System Image (SSI)—Cluster management; provides a single system image for a cluster of systems, load balances network traffic across nodes in the cluster and across clusters, and in the event a storage server fails, transfers processing to a different server in the cluster.

GNU Privacy Guard (GPG): Security; provides key generation (multiple algorithms) and encryption/decryption.

Domain Name System (DNS): IP addressing; provides a directory to map names to IP addresses and to manage traffic among InfraSi storage servers.

Enterprise Volume Management System (EVMS): Administration; provides a flexible means for adding, grouping, and managing all the disk volumes in a cluster. EVMS capabilities include:
Add logical volumes,
Re-stripe,
Monitor usage,
Manage multiple nodes,
Manage logical and physical disks,
Manage external volumes, and
Re-balance to mitigate hot spots.

Heartbeat—Monitoring; monitors the state of a server and transfers control to a second server should the primary server fail.

Data Replication Block Device (DRBD)—Block level data mirroring; provides efficient, reliable block level data mirroring to a remote machine when using ISCSI and Fiber Channel storage area network protocols.

TCP/IP, Fibre Channel, ISCSI, NFS, and CIFS—Network protocols, provide their respective services for Linux/Unix and Windows clients.

Distributed Lock Manager (Open DLM)—Locking; provides the capability for a user or application to lock a file or record until updating is completed. Allows active-active processing.

As mentioned, the network data storage system in accordance with the present invention employs the EXT3 file system running on each storage server. This software keeps track of file locations, file types, etc. for the data stored on a single storage server.

A second open source file system (GFS), also running on each storage server, combines the file system views from each storage server in a cluster to provide a single file view for a cluster of storage servers up to 8 petabytes of storage.

Cluster management software makes multiple computers appear as a single computer. This software is applied to data storage so multiple data storage servers appear as a single storage server. The open source cluster management software Open SSI runs on each storage server. This software presents a cluster of multiple storage servers as a single storage server. Open SSI also provides failover in the case of one or more servers in the cluster failing and load balancing between servers in the cluster.

Through the combination of the server file system, the cluster file system, and the cluster management software users, administrators, and applications see a cluster of multiple storage servers as a single file system and a single server.

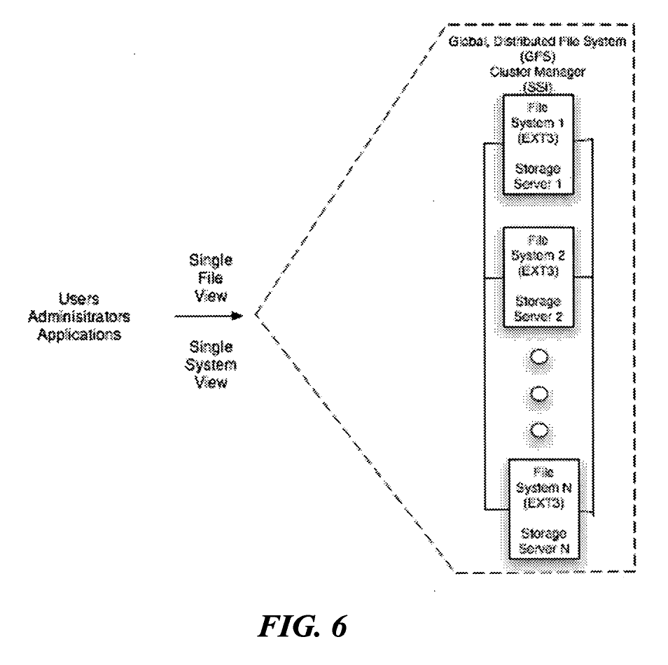

FIG. 6 shows how a cluster of data storage servers is presented as a single file system and system view.

GFS stripes data across all the storage servers in a cluster. A user or application connected to any storage server in the cluster sees all the disks on all the storage servers in the cluster. GFS accesses EXT3 on an individual storage server to store and retrieve data on that server.

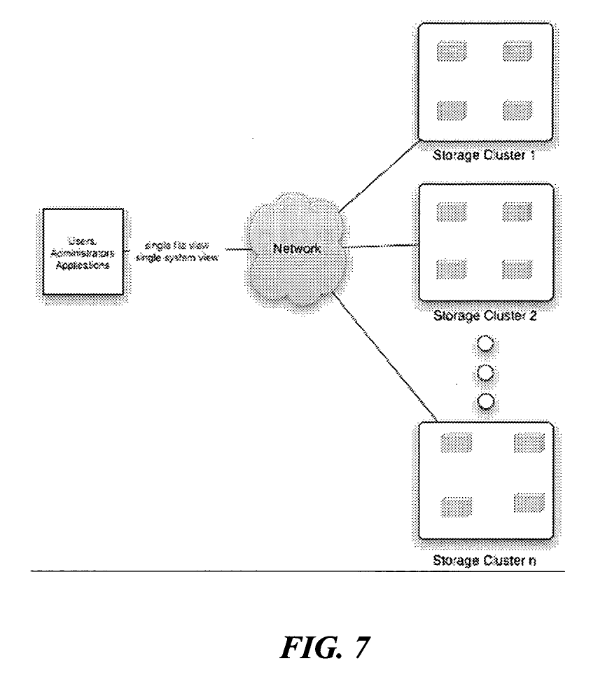

A similar arrangement can provide a single file and system view for multiple clusters of data storage servers. In this case, a third open source file system (AFS), running on each storage server, combines the file system views from multiple inter-connected clusters to provide a single file system view for multiple clusters of storage servers. These clusters may be co-located or geographically disbursed. A high level architecture of this configuration is shown in FIG. 7.

Continuous Data Replication

With the move to on-line, real-time business and government, a failure in the storage system that makes critical content unavailable can have severe consequences. Many storage systems offer protection against some types of failure, such as controller device failure, but not against others, such as a disk drive failure, thus exposing organizations to the risk of data loss or unavailability.

The data storage system in accordance with the present invention uses modified open source software components to provide continuous local and/or remote file level data replication and transparent failover in the event of a problem with any component in the storage system.

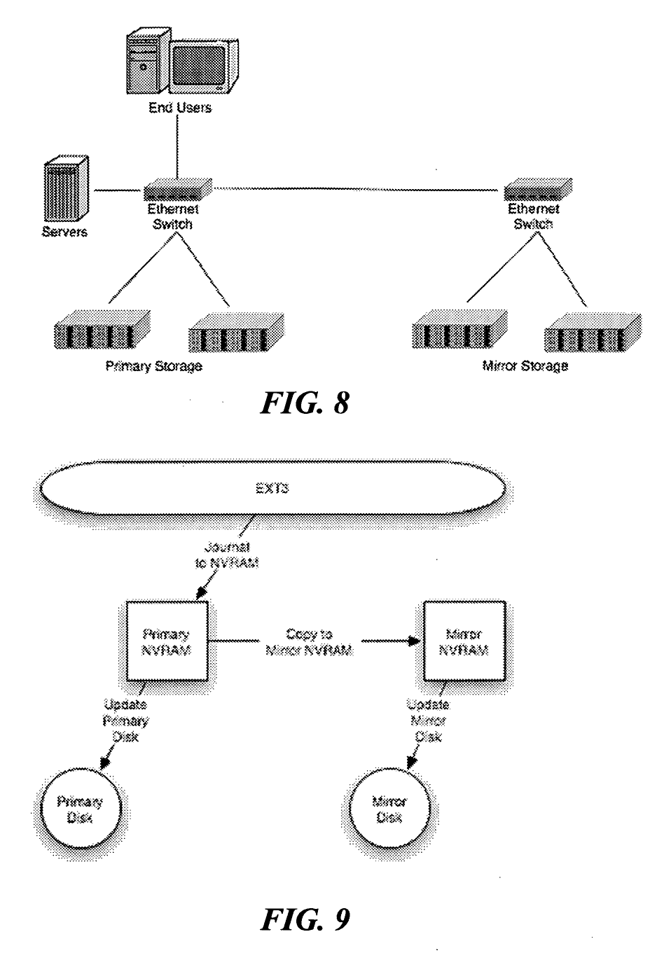

FIG. 8 illustrates an embodiment of the novel data storage system with primary and mirror storage.

The mirror storage can be co-located with the primary storage or installed at a remote location. All Input/Output (I/O) activity on the primary storage server is continuously copied (replicated) to the mirror storage. For the most critical content, the system supports “n-way” replication allowing both local and remote replication.

The continuous replication process is controlled by the modified EXT3 file system running on the primary and mirror storage servers. FIG. 9 shows how data is continuously replicated from a primary storage server to a mirror storage server.

Under control of a properly configured EXT3 file system:
All data is initially transferred into persistent storage (such as battery-backed non-volatile RAM on the primary storage server)
Once the data is loaded into persistent storage:
   Notification is sent to the source of the data (user or application) that the update is complete
   The data is copied to the disks on the primary server
   The data is sent to the mirror server
   The mirror server's disks are updated.
Once the mirror disks are updated, the data in persistent storage on the primary and mirror servers is deleted.

Standard EXT3 functions include writing a copy of all data to a journal file. One modification to EXT3 writes this journal to the primary storage server's persistent storage, sends a completion notification to the source of the data, updates the primary disk(s) from the persistent storage, sends the data to the mirror storage server, records the data in persistent storage on the disk(s) on the mirror storage server, and deletes the data from persistent storage.

When the primary storage system consists of a cluster of data storage servers, each primary storage server replicates to a corresponding mirror storage server.

Automatic Failover

Each mirror storage server constantly checks the status of its corresponding primary server using open source Heartbeat. If the mirror Heartbeat detects that the primary server is not active, it automatically transfers activity from the primary node to the mirror node by reassigning the IP address of the primary node to the mirror node using the DNS IP addressing subsystem.

If the processor on the primary server fails, an emergency reboot operation is initiated. If the emergency reboot is successful, all data from the primary server's persistent storage is transferred to the mirror server's persistent storage.

If a disk drive in a primary storage server fails, read/write activity is automatically transferred to the appropriate mirror disk drive by Linux on the primary server.

Backup Copies Made in Parallel

One challenge in today's environment is ensuring that periodic backup copies are made of critical content. With the demands for 24/7 availability the backup “window” is often insufficient to make complete backup copies of large datasets. The result is that when the inevitable situation arises where backup copies are needed, they are not available or can only be created through large effort and expense.

The hardware architecture and the open source software components used in the instant data storage system provide the ability to make backup copies of all the disks in a data storage server and all servers in a cluster in parallel.

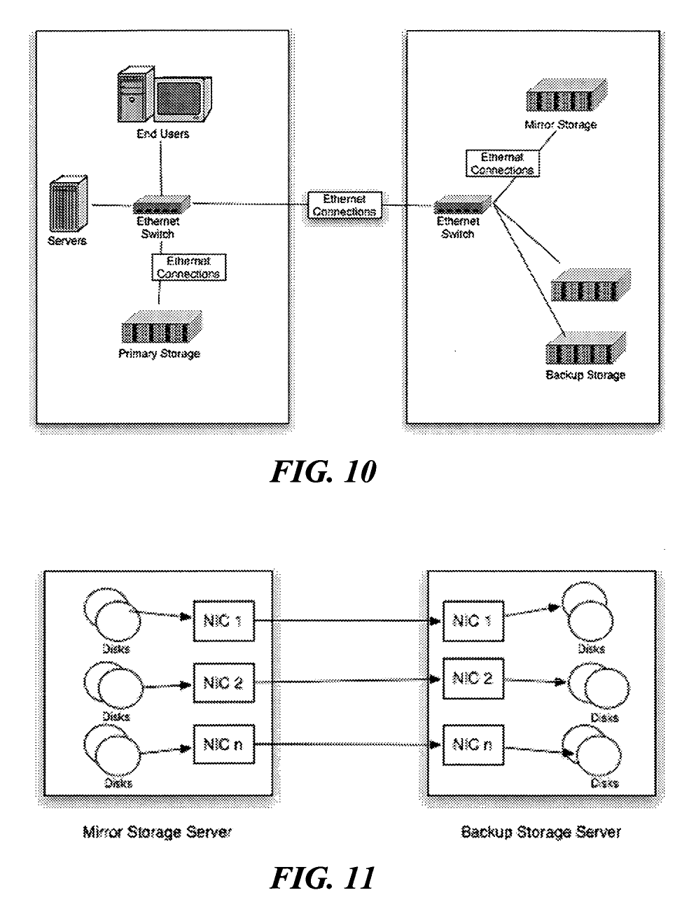

FIG. 10 illustrates an installation of the inventive data storage system with the mirror and backup storage systems located at a remote location. All data is continuously replicated from local primary storage to the remote mirror storage.

The first step in the backup process is to briefly halt update activity on the primary storage system in order to get the primary and mirror storage to a consistent state. Any incoming updates to primary storage are queued for subsequent processing. As soon as the mirror storage catches up with the primary storage (by processing all data from NVRAM on the primary server) the mirror storage is disconnected from the primary storage, and activity on the primary storage resumes.

The backup copy is made by running, e.g., twelve parallel disk copy processes from the mirror storage to the backup storage. By assigning each disk on the mirror and backup storage to specific Network Interface Cards (NICs) the bandwidth available for copying to the backup server is maximized. Once the backup is complete, the mirror storage is reconnected and “catches up” by reading all the queued updates from the primary storage.

Backup copies are IP addressable and immediately available on-line as soon as the backup process is complete. All that is required to access a backup copy is to access the appropriate IP address.

FIG. 11 illustrates the technique for making a backup copy of the data on a storage server.

EVMS quiesces databases and halts processing on the primary storage server.

EXT3 transfers all data from the NVRAM on the primary server to the mirror server (this is normal replication processing).

EVMS terminates the network connection between the primary server and the mirror server, restarts processing on the primary server, and begins storing all data in NVRAM on the primary server.

EVMS assigns disks on the mirror server and backup server to specific network interface cards, and copies disks on mirror server to disks on backup server in parallel.

When backup is complete, EVMS re-establishes the network connection from primary server to the backup server.

EXT3 transfers data in primary server NVRAM to the mirror server.

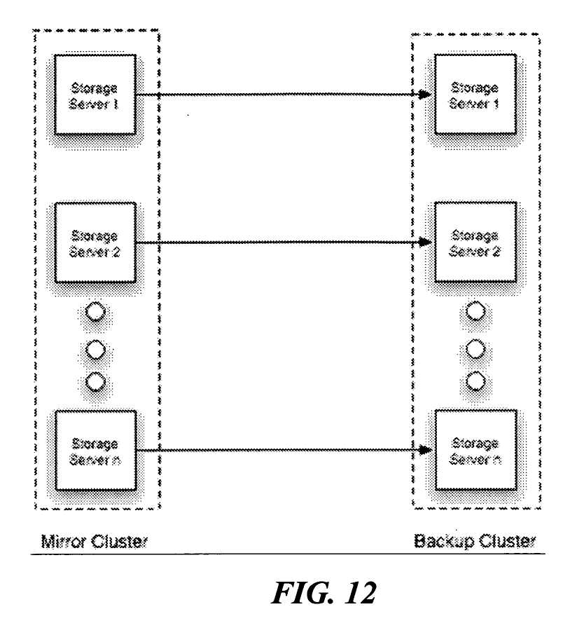

FIG. 12 shows how backup copies are made of a cluster of data storage servers.

As additional storage nodes are added, full copy backup is done in parallel—one mirror storage server to one backup storage server—so full backup copies of any amount of data will still be completed in about one hour. No other storage system provides the ability to make complete backup copies of such large amounts of data, in such a short time, and with such limited impact on primary processing. This allows organizations to make and access the backup copies needed for business or regulatory needs simply, quickly, with minimum impact, and at minimal cost.

Downloading Large Files at a Constant Rate, Without Interruption

Downloading large files, such as video files for on-line viewing, requires transmission at rates of 2 megabits/sec., 4 megabits/sec., or 8 megabits/sec. In addition, any interruption in the transmission will cause “jerky” playback.

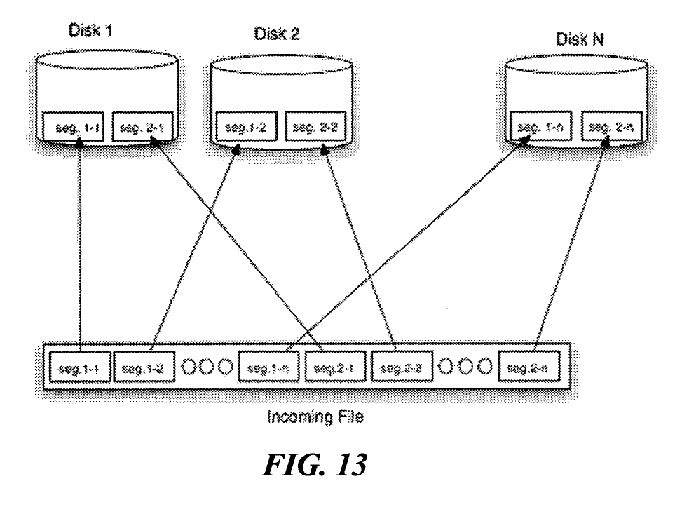

The hardware architecture and open source software components used in the data storage system of the present invention provide the capability to download large files, at rates of 2, 4, or 8 megabit/sec. or higher, without interruption, to multiple users. This process is controlled by the storage server software. FIG. 13 illustrates the approach for handling and storing these files.

The storage server software controls how new files are written to disks.

The file is stored on a single storage server.

The file is striped across all the disks in the server.

The file is written in segments. The size of the segments is a parameter that is set to correspond to the amount of buffer memory available for each user and the number of disks in the server. For example, with 7 megabyte (MB) buffers and 14 disks, the file is divided into 7 MB units, each 7 MB unit is striped across 14 disks with a 0.5 MB segment on each disk).

The first segment from the first unit is written to disk one, the second segment to disk two, etc. The first segment from the second unit is written to disk one, the second to disk two, etc.

The process continues until the entire file is written to disks.

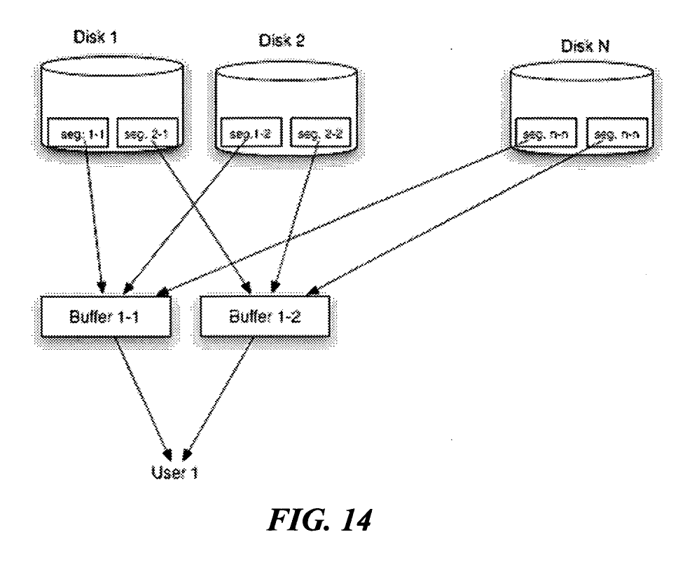

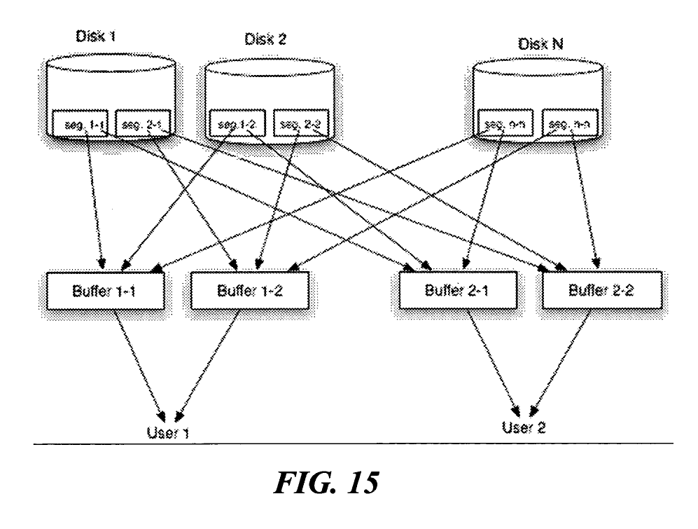

The storage server software also controls how files are retrieved and sent to users as shown in FIG. 14.

When a user requests a file the first buffer is filled by reading the first segment from all the disks into the buffer in parallel.

The portion of the file in the first buffer is sent to the user.

While first portion is being sent, the second buffer is filled by reading all the next segments from all the disks into the second buffer in parallel. When the buffer has been filled, the data in the first buffer is sent to the user.

When the content from the first buffer has all been sent, the data in the second buffer is sent.

While the data in the second buffer is being sent, the next set of segments are read into the first buffer from all the disks in parallel.

This process repeats until the entire file is sent.

The storage server software also controls the process for delivering files to multiple users, as shown in FIG. 15.

Each user is assigned two units of buffer memory.

When the users request files, the first buffer for each user is filled by reading all the first segments for the requested file into the first buffer.

Once the first buffer is filled, the data in the buffer is sent to the user.

While the data in the first buffer is being sent, the second buffer is filled.

This process continues until all files have been delivered to all users.

This approach ensures that specified service levels for file delivery rates and quality are met.

For example, a single storage server with fourteen disk drives can support up to 1000 active users; with each user achieving 2-megabit-per-second (2mbs) file throughput (which is sufficient for streaming DVD quality)—and with each user accessing a different file—or all users accessing the same file—or any variation in-between.

On e thousand users streaming data at 2 mbs each requires a 2-gigabit-per-second (2 gbs) capacity which is supplied using 3 Gigabit Ethernet Network Adapter cards (NICs)—with a conservative aggregate capacity of over 2.5 gbs.

The maximum 2 gbs network capacity needed to support up to 1000 active file stream replications to other machines may be provided by an additional 3 NICs.

A total data bandwidth of 6 gbs (4 gbs for network and 2 gbs for disk streaming) is less than the storage server's 2 PCI busses (with aggregate bandwidth of over 12 gbs).

With data spread over 14 disks; the required aggregate 250 megabytes-per-second throughput (250 MBS)—2 gbs=250 MBS—averages out to about 18 MBS per disk, which is well within any commercially available SATA disk's minimum streaming rate of over 50 MBS.

In accordance with the present invention, there is preferably provided to each user two 7-megabyte (7 MB) buffers, for an aggregate buffer space of 14-gigabytes (14 GB). EXT3 is slightly modified to ensure that as a user's 1 st 7 MB buffer is being filled, their I/O operations are not interrupted by any other user.

In the 28 seconds that it takes to stream the first 7 MB buffer over the network at a 250-kilobytes-per-second rate, (250 KBS=2 mbs); all 999 other users' buffers are filled and the current user's 2 nd 7 MB buffer is filled).

As will be appreciated, the approach is to spread the data required to fill each 7 MB buffer over 14 disks and accomplish each 7 MB buffer-fill by simultaneously reading all 14 disks (with 0.5 MB or 500 KB of data residing on each disk).

For each user: buffer-fill-time in Milliseconds (ms)=disk-seek-time+rotational-delay-time+data-transfer-time.

For the commercially available disks used for this example:
Worst case disk-seek-time=10.2 ms (assumes buffer-fills come from inner and then outer tracks)
Worst case rotational-delay-time=6.0 ms (assumes disk must make full rotation before data transfer)
Average data-transfer-time=8.0 ms (assumes 61.9 MBS disk speed; i.e. outer files=fast, inner=slow)

At 24.2 ms buffer-fill-time per user; all 1000 users will fill their buffers in 24.2 seconds, which is less than the 28-seconds network streaming time for each 7 MB memory buffer.

This is truly a worst case analysis that assumes 1000 active users with all users alternately filling buffers from files on inner and then outer tracks. At the average seek and rotational times of 4.5 ms and 3 ms, the total-buffer-fill-time for 1000 users is just 15.5-seconds (under 60% of our 28-second target).

Maintaining Service Levels by Replication of Large, Heavily Used Files

When demand for a single file from a single storage server exceeds a pre-determined level, the software on the storage server automatically makes a copy of the file and stores in a second storage server. This spreads the workload across multiple servers in a cluster in order to maintain service level.

A policy is set in EVMS for initiating the replication process. The policy can be based on the maximum number of simultaneous user requests that can be supported or a rule based on historic usage statistics.

Bandwidth between the storage server and the network and buffer memory to support the copy process is reserved.

The storage server software monitors download activity and compares against the policy.

When the policy threshold is met, the server software initiates the copy process.

The least busy server in the cluster is identified.

The server software assigns two memory buffers to the copy process and sends a copy of the file to the second server using the same software that is used to send files to users. The server software updates the directory so subsequent request for the file will be balanced between the first and second servers.

This process is repeated as many times as required, based on the policy and the workload, subject to the availability of storage server capacity.

Virtualization of Storage Resources

Storage resource virtualization simplifies storage administration by substituting logical units of storage for physical units, such as disk drives. The instant design uses a combination of open source software components to “virtualize” physical storage resources.

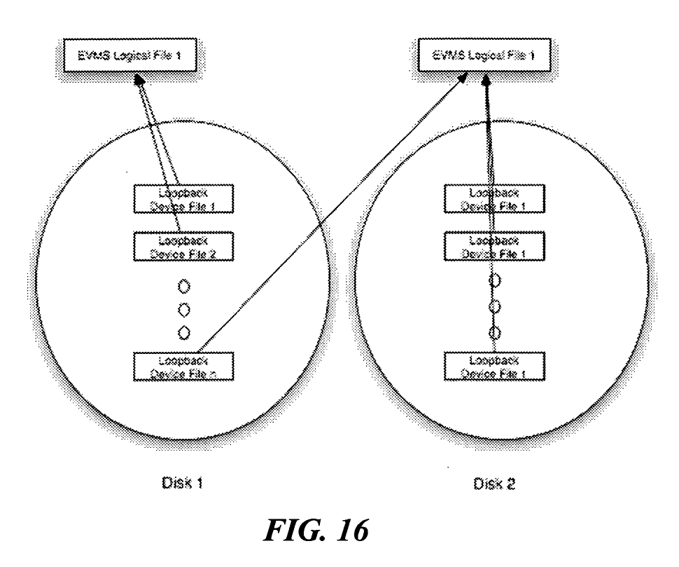

As shown in FIG. 16, the Linux operating system provides the capability to divide physical volumes (disks) into Loopback Device Files. EVMS is used to map Linux Loopback Device Files to EVMS logical volumes. Through EVMS, logical volumes are assigned as storage resources when the storage system is used for block level storage or assigned to the file system when used for file level storage.

This approach (through EVMS) provides capabilities including:
Rebalancing storage resources (Loopback Device Files)—for example, to eliminate “hot spots”
Replicating volumes
Assigning disks (via Loopback Device Files) to logical volumes
Assigning files to logical volumes
Moving files between volumes

As will be appreciated by those skilled in the art, the present invention leverages available Open Source software to provide a unique data storage solution. Unlike proprietary systems whose specific purpose is to provide data storage functionality, the present inventors have found that it is possible, by combining in the fashion described herein, several pieces of Open Source software to accomplish very much the same task. Significantly, however, the Open Source tools being used for this purpose were never designed with network storage in mind. Nevertheless, the present inventors have found appropriate ways to modify and combine these tools to provide a state-of-the-art network data storage solution.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A data storage system, comprising:
a communications bus;
disk drives in communication with the communications bus;
a network adaptor in communication with the communications bus; and
control software controlling the communications bus, disk drives and network adaptor,
wherein a collection of said communications bus, disk drives, network adaptor, and control software constitutes a data storage server, and
wherein the control software consists essentially of open source software.

2. The data storage system of claim 1, wherein the control software comprises the EXT3 node file system.

3. The data storage system of claim 2, wherein the control software comprises GNU Privacy Guard (GPG) security.

4. The data storage system of claim 3, wherein the control software comprises domain name system (DNS) IP addressing.

5. The data storage system of claim 4, wherein the control software comprises an enterprise volume management system (EVMS).

6. The data storage system of claim 5, wherein the control software comprises heartbeat monitoring.

7. The data storage system of claim 6, wherein the control software comprises NFS and CIFS network protocols.

8. The data storage system of claim 7, wherein the control software comprises data replication block device (DRBD) data mirroring.

9. The data storage system of claim 8, wherein the control software comprises a distributed lock manager (DLM).

10. The data storage system of claim 9, comprising a plurality of data storage servers arranged in a cluster.

11. The data storage system of claim 10, wherein the control software comprises a general file system (GFS) and Andrew file system (AFS).

12. The data storage system of claim 11, wherein the control software comprises open single system image (SSI) software.

13. The data storage system of claim 12, wherein the control software comprises Linux.

14. The data storage system of claim 13, wherein the plurality data storage servers can store up to 8 Petabytes of data.

15. A data storage system, comprising:
a plurality of data storage servers arranged in a cluster, each being accessible via a network switch to an external network,
wherein each data storage server comprises a communications bus, disk drives, network adaptor, and control software, and
wherein the control software consists essentially of open source software.

16. The data storage system of claim 15, wherein the control software comprises the EXT3 node file system, GNU Privacy Guard (GPG) security, domain name system (DNS) IP addressing, an enterprise volume management system (EVMS), heartbeat monitoring, NFS and CIFS network protocols, data replication block device (DRBD) data mirroring, a distributed lock manager (DLM), a general file system (GFS) and Andrew file system (AFS), and open single system image (SSI) software.

17. The data storage system of claim 16, wherein the control software comprises Linux.

18. A data storage system, comprising:
a plurality of data storage servers arranged in a cluster, each cluster being accessible via a network switch to an external network,
wherein each data storage server comprises a communications bus, disk drives, network adaptor, and control software,
wherein the control software consists essentially of open source software, the open source software being operable to (i) stripe data across all of the data storage servers in the cluster, (ii) continuous replicate data from a primary storage server to a mirror storage server, and (iii) trigger an automatic failover when the mirror storage server detects inactivity on the part of is corresponding primary storage server.

19. The data storage system of claim 18, wherein the control software comprises at least the EXT3 node file system, domain name system (DNS) IP addressing, an enterprise volume management system (EVMS), heartbeat monitoring, NFS and CIFS network protocols, data replication block device (DRBD) data mirroring, a distributed lock manager (DLM), a general file system (GFS) and Andrew file system (AFS), and open single system image (SSI) software.

20. The data storage system of claim 18, further comprising a plurality of buffers that operate in conjunction with disks on a given storage server to retrieve stored data therein, the buffers and disks being of sufficient size and speed to allow video file playback.
